(19) United States
(12) Patent Application Publication
(10) Pub. No.: US 2016/0244550 A1
(43) Pub. Date: Aug. 25, 2016

(54) HYBRID EPOXY-AMINE HYDROXYURETHANE-GRAFTED POLYMER

(71) Applicants: POLYMATE, LTD., Migdal Ha'Emeq (IL); NANOTECH INDUSTRIES, INC., Daly City, CA (US)

(72) Inventors: Olga Birukov, Haifa (IL); Oleg Figovsky, Haifa (IL); Alexander Leykin, Haifa (IL); Leonid Shapovalov, Nesher (IL)

(21) Appl. No.: 15/146,146

(22) Filed: May 4, 2016

Related U.S. Application Data
(63) Continuation of application No. 14/296,478, filed on Jun. 5, 2014.

(51) Int. Cl. C08G 59/14

(52) U.S. Cl. CPC C08G 59/14

(57) ABSTRACT

Described is a linear hybrid epoxy-amine hydroxyurethane-grafted polymer with the following structure of the polymer backbone unit:

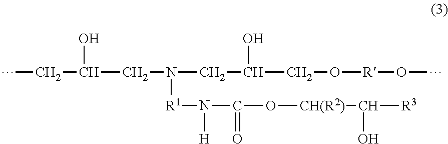

where R′ is a residue of a diglycidyl ether (epoxy resin); R¹ is a residue of a di-primary amine; R² and R³ are residues of monocyclic carbonate and are selected from the group consisting of H, alkyl C₁-C₂, and hydroxymethyl; and at least one of R² and R³ is hydrogen. The described polymer may be used in manufacturing of liquid leather materials.

### BACKGROUND OF THE INVENTION

1. Field of the Invention

The disclosed embodiments relate to hybrid epoxy-amine-hydroxyurethane network polymers with lengthy epoxy-amine chains and pendulous hydroxyurethane units. These hybrid polymers combine increased flexibility with well balanced physical-mechanical and physical-chemical properties of conventional epoxy-amine systems and may be used, for example, for manufacturing of synthetic/artificial leather and sport monolithic floorings.

2. Field of the Invention

The disclosed embodiments relate to hybrid epoxy-amine-hydroxyurethane network polymers with lengthy epoxy-amine chains and pendulous hydroxyurethane units. These hybrid polymers combine increased flexibility with well balanced physical-mechanical and physical-chemical properties of conventional epoxy-amine systems and may be used, for example, for manufacturing of synthetic/artificial leather and sport monolithic floorings.

### DESCRIPTION OF THE RELATED ART

Preparing of polymers with a specific topological structure of polymer chains is a perspective way of creating materials with needed properties.

Conventional epoxy-amine formulations are used as precursors for three-dimensional cross-linked networks. Chemical formation of resin-hardener networks used in case of bifunctional epoxy resins and tetrafunctional amine hardeners and the structures of the obtained networks are described in H. Q. Pham, M. J. Marks. Epoxy resins. In the book: Encyclopedia of Polymer Science and Technology. Copyright John Wiley & Sons, Inc., 3^{rd} ed., 2004, Vol. 9, pp. 678-804_P. 721

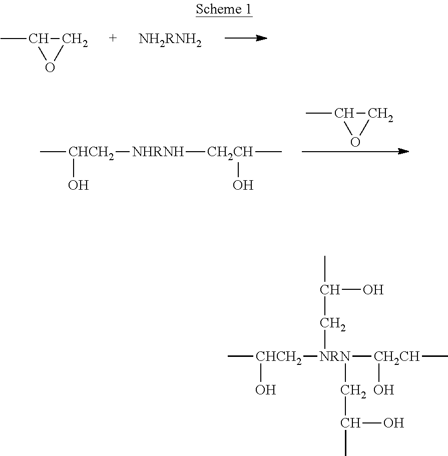

Structural Schemes of resin formation-hardener networks for epoxy-amine thermoset polymers are shown in Scheme 2 [H. Q. Pham, M. J. Marks. Epoxy resins. In the book: Encyclopedia of Polymer Science and Technology. Copyright John Wiley & Sons, Inc., 3^{rd} ed., 2004, Vol. 9, pp. 678-804_P. 749]:

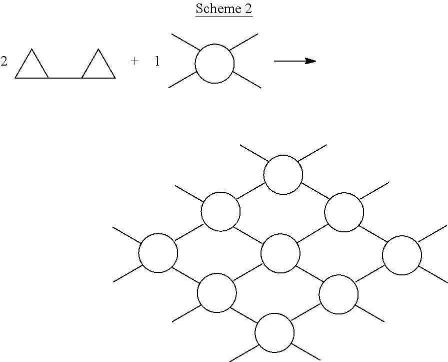

Thermoplastic resins based on epoxy and amine monomers are also known in the art. For example, U.S. Pat. No. 3,317,471 issued in 1967 to Johnson et al. discloses polymers based on diglycidyl ethers of polyhydric phenols and compounds such as alkanolamines and anilines having two amino hydrogen atoms per molecule. The process is carried out at extremely conditions: in a melt at a temperature of up to 250° C. or in a solution at a temperature of up to 200° C.

U.S. Pat. No. 5,275,853 issued in 1994 and U.S. Pat. No. 5,464,924 issued in 1995, both to Silvis, et al. disclose thermoplastic polyetheramines (TPEA) having aromatic ether/amine repeating units in their backbones and pendant hydroxyl moieties. Such polyetheramines are prepared by reacting diglycidyl ethers of dihydric aromatic compounds such as the diglycidyl ether of bisphenol-A (DGEBA), hydroquinone, or resorcinol with amines having no more than two amine hydrogen atoms per molecule, such as piperazine, monoethanolamine (MEA), and mono-amine-functionalized poly(alkylene oxide). These polyetheramines are thermoplastic polymers and have an improved barrier to oxygen and a relatively high flexural strength and modulus. The disadvantage of these products is that they can be processed or melted at temperatures of 150 to 200° C. by using only special equipment, or solutions in high-boiling toxic solvents. A fragment of a TPEA polymer chain is shown below by Scheme 3.

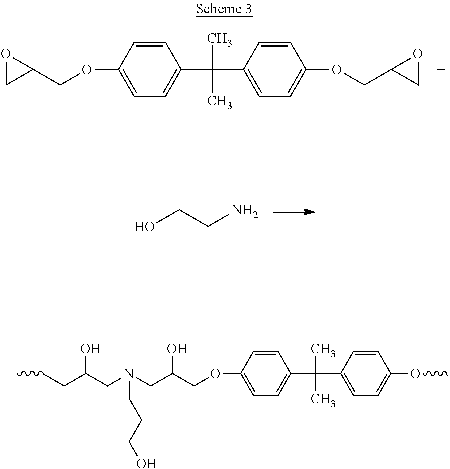

Scheme 3 is described in “Elementary unit of the TPEA polymer chain on the base of DGEBA and MEA.” [Ha. Q. Pham, Maurice J. Marks. Epoxy resins. In the book: Encyclopedia of Polymer Science and Technology. Copyright John Wiley & Sons, Inc., 3^{rd} ed., 2004, Vol. 9, P. 697].

It is known in the art to use hydroxyurethanes for improving some properties of thick cross-linked epoxy polymer networks. For example, U.S. Pat. No. 6,120,905 issued in 2000 to Figovsky describes certain polyhydroxyurethane networks that are produced based on reactions between oligomers comprising terminal cyclocarbonate groups and oligomers comprising terminal primary amine groups. Oligomers comprising terminal cyclocarbonate groups are the products of epoxy resins reacting with carbon dioxide in the presence of a catalyst, the conversion of epoxy groups into cyclocarbonate groups being 85 to 95%.

U.S. Pat. Application Publication No. 20100144966 published in 2010 (inventors: Birukov, et al.) discloses a liquid cross-linkable oligomer composition that contains a hydroxyurethane-amine adduct and a liquid-reacting oligomer. The hydroxyurethane-amine adduct is a product of an epoxy-amine adduct reacting with a compound having one or more terminal cyclocarbonate groups.

U.S. Pat. No. 7,232,877 issued in 2007 to Figovsky, et al. describes a method and an apparatus for synthesis of oligomeric cyclocarbonates and their use in making a star-shaped structure of the polymer network.

U.S. Pat. No. 7,989,553 issued in 2011 to Birukov, et al. discloses three-dimensional epoxy-amine polymer networks modified by a hydroxyalkyl urethane, which is obtained as a result of a reaction between a primary amine (one equivalent of the primary amine groups) and a monocyclic carbonate (one equivalent of the cyclic carbonate groups). Such hydroxyalkyl urethane modifier is not bound chemically to the main polymer network and is represented by the following formula (1):

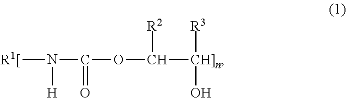

wherein R¹ is a residue of the primary amine, R² and R³ are the same or different and are selected from the group consisting of H, alkyl, and hydroxyalkyl, and n satisfies the following condition: n≧2.

U.S. Pat. No. 5,235,007 issued in 1993 to Alexander, et al. describes an epoxy resin composition that comprises a cured reaction product of an epoxy base resin and a curing agent mixture. The curing agent mixture comprises a di-primary amine or polyamine and an aminohydroxyurethane (aminocarbamate) which is the reaction product of the amine and a cyclic carbonate and is represented by the following formula (2):

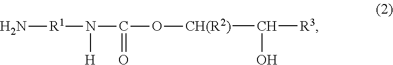

where R¹ is a residue of the di-primary amine or polyamine that may consist additional free amine hydrogen atoms, R² and R³ are selected from the group consisting of H and alkyl, and at least one of R² and R³ is hydrogen. The amine has a molecular weight of 60 to 400. Preferred carbonates are ethylene carbonate and propylene carbonate. A preferred curative comprises a mixture of amine and aminocarbamate used in a molar ratio of 1:1 to 2:1.

Thus, although the hardener comprises the aminohydroxyurethane, a pure amine is an indispensable main component of this hardener, and the final polymer has a thermoset cross-linked structure.

Thick cross-linked networks are also typical for epoxy-aminohydroxyurethane compositions described in U.S. Pat. No. 5,677,006 issued in 1997; U.S. Pat. No. 5,707,741 issued in 1998; U.S. Pat. No. 5,855,961 issued in 1999; and U.S. Pat. No. 5,935,710 issued, in 1993, all to Hoenel, et al., all of which are incorporated by reference.

A method of obtaining urethane-modified amines is presented by G. Rokicki and R. [symbol] aziński in “Polyamines Containing β-Hydroxyurethane Linkages as Curing Agents for Epoxy Resin”, Die Angewandte Makromolekulare Chemie, 1989, Vol. 170, No. 1, 211 to 225 (Nr. 2816).

Triethylene tetramine (TETA) was modified by different mono- and di-cyclic carbonates at mole ratios TETA:carbonate from 1:1 to 4:1 and temperature 50-60° C. for 2-12 hours, thus aminohydroxyurethanes were obtained. The results of physical and mechanical investigations of an epoxy resin crosslinked with the aminohydroxyurethanes show increase of strength features of the cured systems. However flexible materials were not obtained, and values of elongation at break were not more than 8%.

A detailed review of polyhydroxyurethane networks and methods of preparation thereof are presented by O. Figovsky and L. Shapovalov in “Cyclocarbonate-based Polymers Including Non-Isocyanate Polyurethane Adhesives and Coatings”, Encyclopedia of Surface and Colloid Science, Somasundaran. P. (Ed), V. 3, 1633 to 1653, New York, Taylor & Francis, 2006 and by O. Figovsky, L. Shapovalov, A. Leykin, O. Birukova, R. Potashnikova in “Advances in the field of nonisocyanate polyurethanes based on cyclic carbonates. Chemistry & Chemical Technology, 2013, V. 7, No. 1, P. 79-87.

A new polysiloxane-modified polyhydroxy polyurethane resin derived from a reaction between a 5-membered cyclic carbonate compound and an amine-modified polysiloxane compound is disclosed in U.S. Pat. No. 8,703,648 issued in 2014 to Hanada, et al. The production process and resin compositions for thermal recording medium, imitation leather, thermoplastic polyolefin resin skin material, weather strip material, and weather strip also have been described.

Such polymers have in their backbones only hydroxyurethane units but not epoxy-amine. A disadvantage of the disclosed method is an inconvenience in preparation of a polyhydroxy polyurethane resin, namely the long-time use (30 hours for first stage and 10 hours for second stage) of a toxic solvent (N-methylpyrrolidone) at 80-90° C. and subsequent separation of the product from the solvent. Another disadvantage is the use of toxic polyisocyanates for crosslinking of resins.

Different variations of the aforementioned composition and method are also disclosed in other patent publications of Hanada, et al. (US Pat. Application Publication 20140024274 published in 2014; US Pat. Application Publication 20130171896 published in 2013; US Pat. Application Publication 20120232289 published in 2012; and US Pat. Application Publication 20120231184 published in 2012).

### SUMMARY OF THE INVENTION

An object of the present invention is to provide a novel structure of a cured epoxy-amine hydroxyurethane-grafted polymer which contains main backbone of the following formula (3):

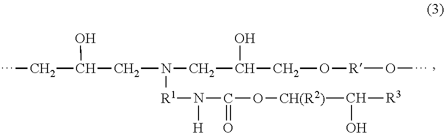

where R′ is a residue of a diglycidyl ether (epoxy resin); R¹ is a residue of the di-primary amine; R² and R³ are residues of monocyclic carbonate and are selected from the group consisting of H, alkyl C₁-C₂, hydroxymethyl, and at least one of R² and R³ is hydrogen.

The schematic structural formula of the novel polymer is the following:

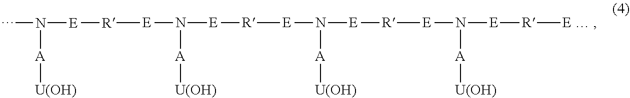

where E-R′-E is a residue of a diglycidyl ether, which reacted with amine hydrogens,

E is a converted epoxy gro

N is a nitrogen atom,

A is a residue of a di-primary amine,

U(OH) is a hydroxyurethane group, and

═N-A-U(OH) is a residue of aminohydroxyurethane formula 2 with the number of free amine hydrogen atoms equal 2.

Another object of the invention is to provide a novel cured epoxy-amine hydroxyurethane-grafted polymer by using a small amount of polyfunctional compounds for creating a controlled number of cross-links, wherein the polyfunctional compounds are selected from the group consisting of polyfunctional epoxy resins, aminohydroxyurethane formula 2 with a number of free amine hydrogen atoms more than 2, and combinations thereof.

A schematic structural formula of the novel polymer with the directions of the possible cross-links (shown by arrows) is the following:

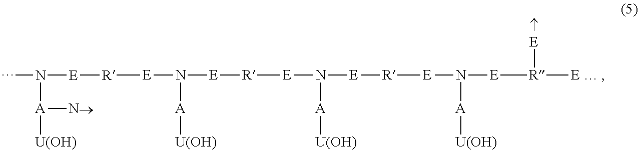

where

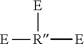

is a residue of the polyfunctional epoxy resin, other designations being the same as above. Polyamines with a number of free amine hydrogen atoms more than 2 also may be used for cross-linking.

### DETAILED DESCRIPTION OF THE INVENTION

This invention relates mainly to a linear hybrid epoxy-amine hydroxyurethane-grafted polymer with the following structure of the polymer backbone unit:

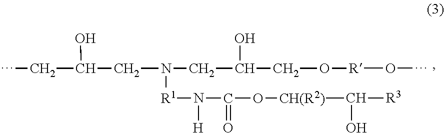

where R′ is a residue of a diglycidyl ether (epoxy resin); R¹ is a residue of a di-primary amine; R² and R³ are residues of monocyclic carbonate and are selected from the group consisting of H, alkyl C₁-C₂, and hydroxymethyl; and at least one of R² and R³ is hydrogen.

The schematic structural formula of the novel polymer is the following:

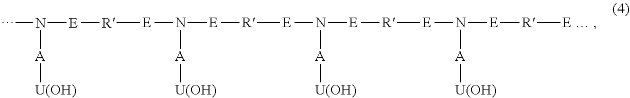

where E-R′-E is a residue of the diglycidyl ether, which reacted with amine hydrogens,
E is a converted epoxy group, i.e., —CH₂—CH(OH)—CH₂—O—,
N is a nitrogen atom,
A is a residue of a di-primary amine,
U(OH) is a hydroxyurethane group, i.e., —R¹—NH—CO—O—CH(R²)—CH(OH)—R³, and
═N-A-U(OH) is a residue of aminohydroxyurethane formula 2 with the number of free amine hydrogen atoms equal 2.

The diglycidyl ethers used in this process are selected from the group consisting of aliphatic diglycidyl ethers, cycloaliphatic diglycidyl ethers, aromatic diglycidyl ethers, polyoxyalkylene diglycidyl ethers, and combinations thereof.

More specifically, the diglycidyl ether may comprise a diglycidyl ether of bisphenol-A or bisphenol-F, hydrogenated diglycidyl ether of bisphenol-A, 1,4-butanediol diglycidyl ether, 1,6-hexanediol diglycidyl ether, neopentyl glycol diglycidyl ether, cyclohexanedimethanol diglycidyl ether, polypropylene glycol diglycidyl ether, dipropylene glycol diglycidyl ether, ethylene glycol diglycidyl ether, and combinations of the aforementioned compounds.

The primary diamines used in the process are selected from the group consisting of aliphatic primary diamines, cycloaliphatic primary diamines, aromatic-aliphatic primary diamines, polyoxyalkylene primary diamines, and combinations thereof.

More specifically, the primary diamine may comprise 2,2,4-(2,4,4)-trimethyl-1,6-hexanediamine, 1,6-hexanediamine, 2-methyl-1,5-pentanediamine, isophorone diamine, cyclohexane diamine, 4,4′-diaminodicyclohexyl-methane, meta-xylylene diamine, polyoxyethylene diamines, polyoxypropylene diamines, polyoxybutylene diamines, and combinations thereof. The monocyclic carbonate used in the process is selected from the group consisting of ethylene carbonate, propylene carbonate, butylene carbonate, glycerine carbonate.

The hybrid epoxy-amine hydroxyurethane-grafted polymer of a novel structure is obtained by curing a liquid oligomer composition which consists of diglycidyl ether and aminohydroxyurethane of structural formula (2) with the number of free amine hydrogen atoms equal to 2:

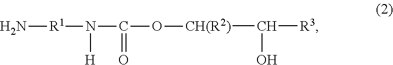

wherein R¹ is a residue of the di-primary amine, R² and R³ are residues of monocyclic carbonate and are selected from the group consisting of H, alkyl C₁-C₂, hydroxymethyl, wherein at least one of R² and R³ is hydrogen, and wherein the diglycidyl ether and aminohydroxyurethane are at stoichiometric ratio of glycidyl groups and free amine hydrogen atoms.

In turn, aminohydroxyurethane is a product of a reaction of di-primary amine and monocyclic carbonate at equimolar ratio, i.e., two primary amine groups are accounted for one cyclic carbonate group.

Alternatively, the hybrid epoxy-amine hydroxyurethane-grafted polymer may also have a number of cross-links obtained by introducing into the initial composition some polyfunctional components for controlling the number of cross-links. The polyfunctional components may comprise polyglycidyl compounds with functionality more than 2, aminohydroxyurethanes of formula 2, wherein R¹ is a residue of the polyamine, with number of free amine hydrogen atoms more than 2, and combinations thereof in amounts of no more than 25 eqv. %.

More specifically, the polyglycidyl compound may comprise aliphatic polyglycidyl ethers, cycloaliphatic polyglycidyl ethers, aromatic polyglycidyl ethers, polyoxyalkylene polyglycidyl ethers and combinations of the aforementioned compounds.

The aminohydroxyurethane with number of free amine hydrogen atoms more than two may comprise monosubstituted hydroxyurethane aliphatic polyamines, monosubstituted hydroxyurethane polyoxyalkylene polyamines and combinations thereof.

The schematic structural formula of the novel polymer with the directions of the possible cross-links (shown by arrows) is the following:

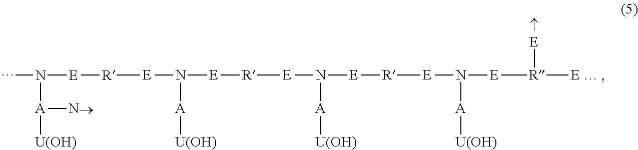

where

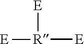

is a residue of the polyfunctional epoxy resin, other designations being the same as above.

Polyamines that have more than two free amine hydrogen atoms also can be used for cross-linking the polymer of the invention.

The following commercially available raw materials are used in the subsequent description:

TABLE 1
List of raw materials

| Name | Manufacturer | Description | Abbreviation |
|---|---|---|---|
| Epoxy resin D.E.R. ® | Dow Chemical | Diglycidyl ether of | DER 331 |
| 331 | Company, MI, USA | Bisphenol A | |
| EEW = 187 | | | |
| Epoxy resin D.E.N. ® | Dow Chemical | Epoxy-novolac | DEN 431 |
| 431 | Company, MI, USA | resin | |
| EEW = 175 | | | |
| Epoxy resin ST- | KUKDO Chemical Co., | Hydrogenated | ST-3000 |
| 3000 | Korea | DGEBA | |
| EEW = 230 | | | |
| Polypox ® R11 | Dow Chemical, | Diglycidyl ether of | R11 |
| EEW = 175 | Germany | cyclohexanedimethanol | |
| Polypox ® R14 | Dow Chemical, | Diglycidyl ether of | R14 |
| EEW = 155 | Germany | neopentyl glycol | |
| Heloxy ® 48 | Momentive Specialty | Triglycidyl ether of | H48 |
| EEW = 145 | Chemicals Inc., OH, US | trimethylol propane | |
| Jeffsol ® PC | Huntsman Corp., TX, | Propylene | PC |
| CCEW = 102 | USA | carbonate | |
| Vestamin ® TMD | Evonik, Germany | 2,2,4-(2,4,4)- | TMD |
| AEW = 79; | | Trimethyl-1,6- | |
| AHEW = 39.5 | | hexanediamine | |
| Jeffamine ® D400, | Huntsman Corp., TX, | Polyoxypropylene | D-400 |
| AEW = 230; | USA | diamine | |
| AHEW = 115 | | | |
| Jeffamine ® T403 | Huntsman Corp., TX, | Polyoxypropylene | T-403 |
| AEW = 162; | USA | triamine | |
| AHEW = 81 | | | |
| PolyTHF ®Amin 350 | BASF, Germany | Polytetrahydrofuran | PTHFA 350 |
| AEW = 160.3 | | amine | |
| AHEW = 88 | | | |
| MXDA | Mitsubishi Gas | Meta- | MXDA |
| AEW = 68; AHEW = 34 | Chemical Comp., | xylylenediamine | |
| | Japan | | |
| D.E.H. ® 20 | Dow Chemical | Diethylenetriamine | DETA |
| AEW = 51.5; | Company, MI, USA | | |
| AHEW = 20.6 | | | |

Additional abbreviation:
1) EEW—epoxy equivalent weight;
2) AEW—primary amine equivalent weight;
3) AHEW—amine hydrogen equivalent weight;
4) CCEW—cyclic carbonate equivalent weight;
5) f—functionality for epoxy compound.

The invention will be further described by way of application examples which, however, should not be construed as limiting the scope of the invention application.

### EXAMPLES

The components participated in the reactions shown in the examples were used in the stoichiometric ratios given below.

a) Stoichiometric ratio for a reaction of cyclic carbonate with amine is 1 CCEW:1 AEW.

b) Stoichiometric ratio for a reaction of epoxy compound with amine is 1 EEW:1 AHEW.

The following hydroxyurethane-amine compounds were synthesized for use in the examples as intermediate products

Hydroxyurethane-Monoamine HUMA-1

158 g (2.0 AEW) of TMD and 102 g (1.0 CCEW) of PC, equivalent ratio 2:1, were put into a 500 ml flask and then the mixture was stirred for 10 min. The reaction mixture was kept in the flask at room temperature during 3 hours and the consumption of the cyclic carbonate groups was controlled by spectrometer FT/IR (wavelength 1800 cm⁻¹).

Calculated ANEW of HUMA-1 was 130, f=2.

Viscosity (25° C.) was 9.15 Pa·s.

Hydroxyurethane-Monoamine HUMA-2

136 g (2.0 AEW) of MXDA and 102 g (1.0 CCEW) of PC, equivalent ratio 2:1, were put into a 500 ml flask and then the mixture was stirred for 10 min. The reaction mixture was kept in the flask at room temperature during 3 hours and the consumption of the cyclic carbonate groups was controlled by spectrometer FT/IR (wavelength 1800 cm⁻¹).

Calculated AHEW of HUMA-2 was 119, f=2.

Viscosity (50° C.) was 1.48 Pa·s.

Hydroxyurethane-Monoamine HUMA-3

230 g (1.0 AEW) of D-400 and 51 g (0.5 CCEW) of PC, equivalent ratio 2:1, were put into a 500 ml flask and then the mixture was stirred at room temperature for 10 min. The reaction mixture was kept in the flask at temperature 90° C. during 6 hours and the consumption of the cyclic carbonate groups was controlled by spectrometer FT/IR (wavelength 1800 cm⁻¹).

Calculated AHEW of HUMA-3 was 281, f=2.

Viscosity (25° C.) was 0.45 Pa·s.

Hydroxyurethane-Monoamine HUMA-4

175 g (1.0 AEW) of PTHFA 350 and 51 g (0.5 CCEW) of PC, equivalent ratio 2:1, were put into a 500 ml flask and then the mixture was stirred at room temperature for 10 min. The reaction mixture was kept in the flask at temperature 90° C. during 3 hours and the consumption of the cyclic carbonate groups was controlled by spectrometer FT/IR (wavelength 1800 cm⁻¹).

Calculated AHEW of HUMA-4 was 226, f=2.

Viscosity (25° C.) was 0.7 Pa·s.

Hydroxyurethane-Polyamine HUPA-1

243 g (1.5 AEW) of T-403 and 51 g (0.5 CCEW) of PC, equivalent ratio 3:1, were put into a 500 ml flask and then the mixture was stirred at room temperature for 10 min. The reaction mixture was kept in the flask at temperature 90° C. during 6 hours and the consumption of the cyclic carbonate groups was controlled by spectrometer FT/IR (wavelength 1800 cm⁻¹).

Calculated ANEW of HUPA-1 was 147, f=4.

Viscosity (25° C.) was 3.74 Pa·s.

Hydroxyurethane-Polyamine HUPA-2

103 g (2.0 AEW) of DETA and 102 g (1.0 CCEW) of PC were put into a 500 ml flask and then the mixture was stirred at room temperature for 10 min. The reaction mixture was kept in the flask at room temperature during 1 hour and the consumption of the cyclic carbonate groups was controlled by spectrometer FT/IR (wavelength 1800 cm⁻¹).

Calculated ANEW of HUPA-2 was 68.3, f=3.

Viscosity (25° C.) was 6.7 Pa·s.

### Application Example 1

17.5 g (0.1 EEW) of R11 and 13.0 g (0.1 AHEW) of HUMA-1 were mixed at RT for 2 minutes. Then the mixture was poured into standard moulds and cured at RT for 7 days. As a result, hybrid epoxy-amine hydroxyurethane-grafted polymer No. 1 was obtained (see Table 2 below).

### Application Example 2

15.5 g (0.1 EEW) of R14 and 11.9 g (0.1 AHEW) of HUMA-2 were mixed at RT for 2 minutes. Then the mixture was poured into standard moulds and cured at RT for 7 days. As a result, hybrid epoxy-amine hydroxyurethane-grafted polymer No. 2 was obtained (see Table 2 below).

### Application Example 3

18.7 g (0.1 EEW) of DER 331 and 28.1 g (0.1 AHEW) of HUMA-3 were mixed at RT for 2 minutes. Then the mixture was poured into standard moulds and cured at RT for 7 days. As a result, hybrid epoxy-amine hydroxyurethane-grafted polymer No. 3 was obtained (see Table 2 below).

### Application Example 4

23.0 g (0.1 EEW) of ST-3000 and 22.6 g (0.1 AHEW) of HUMA-4 were mixed at RT for 2 minutes. Then the mixture was poured into standard moulds and cured at RT for 7 days. As a result, hybrid epoxy-amine hydroxyurethane-grafted polymer No. 4 was obtained (see Table 2 below).

### Application Example 5

19.64 g (0.105 EEW) of DER 331, 2.9 g H48 (0.02 EEW), 12.35 g (0.095 AHEW) of HUMA-1 and 4.4 g (0.03 AHEW) of HUPA-1 were mixed at RT for 2 minutes. Contents of cross-linking agents 20% (by equivalents). As a result, hybrid epoxy-amine hydroxyurethane-grafted polymer No. 5 was obtained (see Table 2 below). Then the mixture was poured into standard moulds and cured at RT for 7 days.

### Application Example 6

14.0 g (0.08 EEW) of R11, 3.5 g DEN 431 (0.02 EEW), 8.3 g (0.07 AHEW) of HUMA-2 and 2.05 g (0.03 AHEW) of HUPA-2 were mixed at RT for 2 minutes. Contents of cross-linking agents 25% (by equivalents). Then the mixture was poured into standard moulds and cured at RT for 7 days. As a result, hybrid epoxy-amine hydroxyurethane-grafted polymer No. 6 was obtained (see Table 2 below).

Testing of the hybrid epoxy-amine hydroxyurethane-grafted polymers obtained in Examples 1 to 6

The polymerized samples were tested with regard to the following mechanical and chemical properties:

Pot Life (2× viscosity) (in accordance with ASTM D1084)

Tensile strength (in accordance with ASTM D638M)

Ultimate Elongation (in accordance with ASTM D638M)

Hardness (Shore D) (in accordance with ASTM D2240)

Weight gain at immersion in water (24 h @ 25° C.) (in accordance with ASTM D570)

Weight gain at immersion in 20% H₂SO₄ (24 h @ 25° C.) (in accordance with ASTM D543)

The results of the tests are summarized in Table 2 given below.

TABLE 2
Properties Data of compositions according examples 1-6.

| | Application Examples No. | | | | | |
|---|---|---|---|---|---|---|
| Measured Characteristics | 1 | 2 | 3 | 4 | 5 | 6 |
| Pot life, min | 60 | 40 | 60 | 50 | 25 | 30 |
| Hardness, Shore D | 15 | 20 | 35 | 20 | 44 | 60 |
| Tensile strength, MPa | 1.1 | 0.9 | 3.0 | 2.4 | 12 | 10 |
| Elongation at break, % | 147 | 130 | 275 | 183 | 72 | 73 |
| Weight gain at immersion in | 1.1 | 1.8 | 0.3 | 0.3 | 0.2 | 0.1 |
| water (24 h @ 25° C.), % | | | | | | |
| Weight gain at immersion in | 1.1 | 1.4 | 0.6 | 0.5 | 0.3 | 0.1 |
| 10% NaOH (24 h @ 25° C.), % | | | | | | |

### Practical Example

### Manufacturing of Synthetic Leather

The coating formulations for imitation leathers, which contained the components described in Examples 1 to 3, were separately applied onto paper sheets and cured by drying to form on the paper substrate films of incompletely cured polymer coating having a thickness of 25 μm, respectively. The thus-obtained coated products were cut into separated pieces, applied onto a fabric substrates (see Table 3) and bonded to the substrates under pressure developed by a load. After bonding to the fabric and solidification of the coating, the paper substrates were peeled off. As a result, samples A, B, and C of the synthetic leather shown in Table 3 were obtained.

Tensile properties of the samples were determined according ASTM D638.

Cold crack resistance was measured according to CFFA-6 (STANDARD TEST METHODS. CHEMICAL COATED FABRICS AND FILM. Chemical Fabrics & Film Association, Inc. Cleveland, 2011).

TABLE 3
Main Properties of Synthetic Leather

| | | Tensile | | Cold crack |
|---|---|---|---|---|
| | | Strength, | Elongation, | resistance, |
| Sample | Fabric type | MPa | % | ° C. |
| A | non-woven synthetic soft | 70 | 45 | −20 |
| B | non-woven synthetic hard | 76 | 33 | −20 |
| | thin | | | |
| C | thin synthetic knitwear | 24 | 155 | −20 |

The hybrid epoxy-amine hydroxyurethane-grafted polymer No. 1 was used as in Sample A, the hybrid epoxy-amine hydroxyurethane-grafted polymer No. 2 was used as in Sample B, and the hybrid epoxy-amine hydroxyurethane-grafted polymer No. 3 was used as in Sample C.

It is to be understood that both the foregoing and the following descriptions are exemplary and explanatory only and are not intended to limit the claimed invention or application thereof in any manner whatsoever.

What is claimed is:

1. A hybrid epoxy-amine hydroxyurethane-grafted polymer with controlled number of cross-links having a main backbone unit represented by the following formula (3): 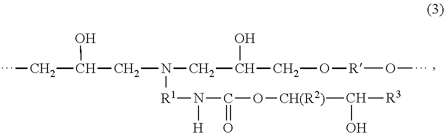
wherein: R′ is a residue of a diglycidyl ether; R¹ is a residue of the di-primary amine; R² and R³ are residues of monocyclic carbonate and are selected from the group consisting of H, alkyl C₁-C₂, and hydroxymethyl;
and wherein at least one of R² and R³ is hydrogen;
and wherein the hybrid epoxy-amine hydroxyurethane-grafted polymer composition consist polyfunctional compound, wherein said polyfunctional compound is selected from
the group consisting of polyglycidyl ethers with functionality more than 2, aminohydroxyurethanes of formula 2, wherein R¹ is a residue of the polyamine, with number of free amine hydrogen atoms more than 2, and combinations of thereof in amount of not more than 25 eqv. %.

2. The hybrid epoxy-amine hydroxyurethane-grafted polymer of claim 1, wherein the diglycidyl ether is selected from the group consisting of aliphatic diglycidyl ethers, cycloaliphatic diglycidyl ethers, aromatic diglycidyl ethers, polyoxyalkylene diglycidyl ethers and combinations thereof.

3. The hybrid epoxy-amine hydroxyurethane-grafted polymer of claim 2, wherein the aromatic diglycidyl ethers are selected from the group consisting of diglycidyl ethers of bisphenol-A and bisphenol-F; the cycloaliphatic diglycidyl ethers are selected from the group consisting of hydrogenated diglycidyl ether of bisphenol-A and cyclohexanedimethanol diglycidyl ether; the aliphatic diglycidyl ethers are selected from the group consisting of 1,4-butanediol diglycidyl ether, 1,6-hexanediol diglycidyl ether and neopentyl glycol diglycidyl ether; and polyoxyalkylene diglycidyl ethers are selected from the group consisting of polypropylene glycol diglycidyl ethers, dipropylene glycol diglycidyl ethers, ethylene glycol diglycidyl ethers, and combinations thereof.

4. The hybrid epoxy-amine hydroxyurethane-grafted polymer of claim 1, wherein said polyglycidyl compound is selected from the group consisting of aliphatic polyglycidyl ethers, cycloaliphatic polyglycidyl ethers, aromatic polyglycidyl ethers, polyoxyalkylene polyglycidyl ethers and combinations thereof.

5. The hybrid epoxy-amine hydroxyurethane-grafted polymer of claim 1, wherein said primary diamine is selected from the group consisting of aliphatic primary diamines, cycloaliphatic primary diamines, aromatic-aliphatic primary diamines, polyoxyalkylene primary diamines and combinations thereof.

6. The hybrid epoxy-amine hydroxyurethane-grafted polymer of claim 4, wherein the primary diamine is selected from the group consisting of 2,2,4-(2,4,4)-trimethyl-1,6-hexanediamine, 1,6-hexanediamine, 2-methyl-1,5-pentanediamine, isophorone diamine, cyclohexane diamine, 4,4′-diaminodicyclohexyl-methane, meta-xylylene diamine, polyoxyethylene diamines, polyoxypropylene diamines, polyoxybutylene diamines and combinations thereof.

7. The hybrid epoxy-amine hydroxyurethane-grafted polymer of claim 1, which is a product obtained by curing a liquid oligomer composition comprising diglycidyl ether, polyglycidyl ethers with functionality more than 2, aminohydroxyurethane with the number of free amine hydrogen atoms equal 2: 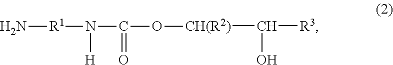
wherein R¹ is a residue of the di-primary amine,
R² and R³ are residues of monocyclic carbonate and are selected from the group consisting of H, alkyl C₁-C₂, hydroxymethyl and at least one from R² and R³ is hydrogen, and
aminohydroxyurethane with the number of free amine hydrogen atoms more than 2
at stochiometric ratio of glycidyl groups and free amine hydrogen atoms.

8. The hybrid hydroxyurethane-grafted polymer of claim 7, wherein said aminohydroxyurethane of formula (2) is a product of a reaction of the di-primary amine and the monocyclic carbonate at an equimolar ratio.

9. The hybrid hydroxyurethane-grafted polymer of claim 7, wherein said aminohydroxyurethane with the number of free amine hydrogen atoms more than 2 is selected from the group consisting of monosubstituted hydroxyurethane aliphatic polyamines, monosubstituted hydroxyurethane polyoxyalkylene polyamines and combinations thereof.

10. The hybrid hydroxyurethane-grafted polymer of claim 7, wherein said aminohydroxyurethane with the number of free amine hydrogen atoms more than 2 is a product of reaction the polyamine and the monocyclic carbonate at an equimolar ratio.

11. The hybrid hydroxyurethane-grafted polymer of claim 1, wherein said hybrid
hydroxyurethane-grafted polymer has the following formula: 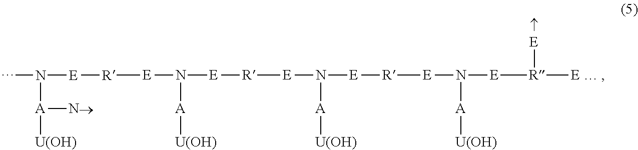
where E-R′-E is a residue of a diglycidyl ether, 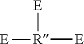
is a residue of the polyfunctional epoxy resin,
E is a converted (reacted with amine hydrogen) epoxy group,
N is a nitrogen atom,
A is a residue of a di-primary amine,
U(OH) is a hydroxyurethane group,
═N-A-U(OH) is a residue of aminohydroxyurethane formula 2 with the number of free amine hydrogen atoms equal 2, and
═N-A(N→)—U(OH) is a residue of aminohydroxyurethane with the number of free amine hydrogen atoms more than 2.
